(19) United States
(12) Patent Application Publication
(10) Pub. No.: US 2009/0011224 A1
(43) Pub. Date: Jan. 8, 2009

(54) FORMATION OF LARGE ARRAYS OF ZINC OXIDE NANOSTRUCTURES USING ELECTRODEPOSITION

(75) Inventors: Ganapathi Subramaniam NAGARAJAN, Salem (IN); Juwon LEE, Seoul (KR); Tae Won KANG, Seoul (KR)

Correspondence Address: Momkus McCluskey, LLC, 1001 Warrenville Road, Suite 500, Lisle, IL, 60532, US

(73) Assignee: NOVAKOR, INC., Sarasota, FL (US)

(21) Appl. No.: 12/167,671

(22) Filed: Jul. 3, 2008

(30) Foreign Application Priority Data
Jul. 3, 2007 (KR) 10-2007-0066655

(51) Int. Cl. B32B 5/16; C25D 9/04; C25D 5/10; C25D 5/12

(52) U.S. Cl. 428/328; 205/333; 205/170; 205/181; 205/176

(57) ABSTRACT

In an aqueous solution of a zinc salt, counter, reference and working electrodes are placed, and an electric potential is applied across the working and reference electrodes. A gas including oxygen and an inert gas is introduced into the aqueous solution. Responsive to these conditions an array of zinc oxide nanostructures grows on a conductive nucleation plate that is a part of the working electrode. The nanostructures have sharp tips, have a more efficient electron emissivity than nanorods made from other materials, and can be used in fabricating field emission lamps and displays.

### BACKGROUND OF THE INVENTION

Much present-day scientific research involving information technology, display devices and the materials to make such devices is focused on nanotechnology in order to further advance miniaturization. One approach is from the bottom up, and concerns the synthesis of nanostructures which have utility in the semiconductor art. Zero-dimensional quantum dots, one-dimensional quantum wires, nanowires and nanorods have been widely suggested.

International research efforts to synthesize nanostructures have included semiconductors such as silicon, germanium, Al—Ga—In—P—N systems, ZnO, SnO₂ and SiC. In particular, the oxide semiconductor ZnO has a wurtzite structure with direct band-gap energy of 3.37 eV and a very high excition binding energy of 60 meV at room temperature. If problems concerning production can be overcome, ZnO based materials could replace conventional materials in areas which require high emission characteristics.

Field emission displays or FEDs are a type of flat panel display which uses field emitting cathodes to bombard phosphor coatings as the light-emissive medium. Conventional FEDs use a large array of fine metal tips or carbon nanotubes, with many positioned behind each phosphor dot. Because of emitter redundancy, FEDs do not display dead pixels like LCDs, even after 20% of the emitters have failed. FEDs are presently being researched as having promise in matching or exceeding the quality of a cathode ray tube (CRT), at much less power consumption than liquid crystal displays or plasma display technologies. But the feasibility of mass-producing FEDs for the consumer market has yet to be demonstrated. Field Emission Lamps (FELs) have been discussed which are similar to FEDs but which provide general illumination.

### SUMMARY OF THE INVENTION

According to one aspect of the invention, a method is disclosed whereby large arrays of zinc oxide nanostructures are grown by means of electrodeposition. In an aqueous solution of a zinc salt there is placed a working electrode including a conductive nanostructure nucleating surface, a counter electrode and a reference electrode. A gas including oxygen is introduced into the aqueous solution. A predetermined electric potential is applied across the working and reference electrodes. Under these conditions an array of upstanding spaced-apart nanostructures of zinc oxide begins to grow on the nucleating surface, wherein a basal diameter of each nanostructure adjacent the nucleation surface is on the order of 200 nanometers to one micrometer.

Preferably, the zinc salt is one with a high solubility in water and more preferably is selected from the group consisting of ZnNO₃ and ZnCl₂. At the beginning of the process, the zinc salt should be present in a concentration of about 0.0001 M to about 0.03 M. Preferably, the concentration of zinc in the aqueous solution is maintained at or above a predetermined minimum, all through a first growth period. If this is done, during this first period the nanostructures will grow as prismatic rods or structures, of substantially constant areal cross-section. During a second period, which can merely be a continuation of the first period under the same reaction conditions, the concentration of zinc drops, as by exhausting itself by being electrodeposited on the free ends of the nanorods or structures. As the concentration of zinc drops below the predetermined minimum, the areal cross section of a second length of the structure will begin to shrink. In this way, a sharp tip on the end of a nanotower can be achieved.

The nucleation surface is conductive and it can be chosen to be light-transparent. Preferably, the nucleation surface is a transparent coating or film on a transparent substrate such as glass. The conductive coating can for example be indium tin oxide (ITO), platinum, aluminum, gold, silver, nickel, aluminum tin oxide, zinc oxide, cadmium oxide, tin oxide, or indium oxide.

Among the technical advantages of this invention's fabrication process are that it does not require any catalyst, it can be produced using a large area nucleation surface (theoretically extending to square meters) thereby lending itself to field emission applications, it can be performed at atmospheric pressure, and it can be performed at temperatures of less than 100 C. The duration of the process is significantly less than prior art nanorod fabrication processes.

According to another aspect of the invention, the above process produces an array of zinc oxide nanostructures on a conductive nucleation surface. Each nanostructure has a base on the order of 200 nanometers to one micrometer in diameter and has a tip, which is spaced from a tip of a next adjacent nanostructure by about 250 nanometers to one micrometer. A free end of each nanostructure is pointed, enhancing the utility of the nanostructure as an efficient electron emitter. Preferably, each nanostructure is a hexagonal nanotower wherein, throughout a first length starting from its base on the nucleation surface, the nanotower has a substantially uniform cross-sectional area. A second length of the nanotower, spaced from the nucleation surface by the first length, has a cross-sectional area which decreases as a function of the distance from the nucleation surface, and preferably terminates in a point. More preferably the first length of the nanotower substantially takes the form of a hexagonal prism and the second length substantially takes the form of a hexapyramid. Each nanotower is monocrystalline, permitting its operation as a semiconductor-based electron emitter for field emission applications.

As deposited on a transparent substrate such as glass, the hexagonal nanotower array of the invention has particular utility as an electronic emitter component of a field emission display or lamp. Very large area displays can be formed using this invention, as there are no constraints imposed by the pressure under which the process is conducted (it can be atmospheric rather than be done in a vacuum) or temperature. The produced field emission display requires no manual patterning and no metallization of the individual emitters. Each nanotower has a high aspect ratio.

### BRIEF DESCRIPTION OF THE DRAWINGS

Further aspects of the invention and their advantages can be discerned in the following detailed description, in which like characters denote like parts and in which:

FIG. 1 is a schematic diagram showing an electrodeposition chamber for synthesizing nanostructures in a process according to the invention;

FIG. 2 is an idealized model of a nanotower/nanostructure array formed using the process of the invention;

FIGS. 3-9 are scanning electron microscopy (SEM) images of ZnO nanostructures grown on ITO/glass substrates according to the invention;

FIG. 10 is a scanning electron microscopy (SEM) image of a ZnO nanostructure array grown on a nickel/glass substrate;

FIG. 11 is an X-ray diffraction graph of intensity v. angle (2θ) to show the crystal structure of nanostructures synthesized using the electrodeposition process of the invention; and

FIG. 12 is a graph of photoluminescence v. wavelength at room temperature of nanostructures fabricated according to the invention, showing optical emission properties and crystal quality of these structures.

### DETAILED DESCRIPTION

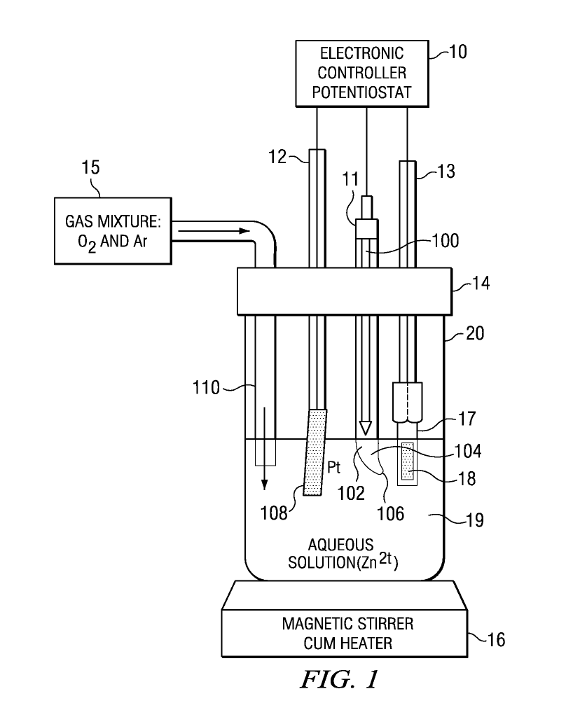

FIG. 1 depicts laboratory bench apparatus for carrying out the process of the invention. In a vessel 20 is placed an aqueous solution 19 of a water-soluble zinc salt. It is preferred that the zinc salt be selected from zinc nitrate, zinc chloride and mixtures thereof. It is particularly preferred to use ZnCl₂. The zinc salt should be present in a concentration in the range of about 0.0001 M to 0.03 M. Preferably the zinc salt should be present in a concentration from 0.0007 M to 0.009 M. Most preferably the zinc salt should be present in a concentration from 0.001 M to 0.007 M.

The solvent preferably is deionized water in order to eliminate impurities in crystal formation. It is preferred that the solution also contain a supporting electrolyte such as KCl, EuCl₂ or KNO₃. Preferably the supporting electrolyte should be present in concentrations of 0.001 M to 0.3 M. More preferably the supporting electrolyte should be present in concentrations of 0.009 M to 0.03 M. It is preferred that the supporting electrolyte match the precursor to a certain extent. The supporting electrolyte also serves to increase the conductivity of the solution.

Three electrodes are suspended in the solution 19: a counter electrode 12, a reference electrode 11 and a working electrode 13. The working electrode 13 includes a conductive nucleating surface 18. It is preferred that this nucleating surface 18 be a coating or film on a substrate 17. A conductive connection should be made to the nucleating surface 18. It is also preferred that both the substrate 17 and the conductive nucleating surface 18 be transparent to light. In particularly preferred embodiment, the substrate 17 is glass, and the coating or film 18 is formed of a transparent conductive film such as one made of Platinum, Aluminum, Gold, Silver, Nickel, Indium Tin Oxide (ITO), Indium Zinc Oxide (IZO), Aluminum Tin Oxide (ATO), Zinc Oxide, Cadmium Oxide, Tin Oxide, Indium Oxide, or alloys of the foregoing metals. It is particularly preferred to use ITO since this is a transparent nondegenerate semiconductor with good compatibility to the grown nanostructures. Nickel is an alternative preferred nucleating surface. Where ITO is used as the conductive transparent coating 18, it should be deposited on the substrate 17 to a thickness in the range of about 100 to about 400 nm. In the illustrated laboratory bench embodiment, the area of nucleating surface 18 is about 5 cm². In an alternative embodiment the substrate 17 can be flexible and fabricated of flexible polymers with a conductive coating. Such an alternative embodiment is suitable for flexible displays.

The reference electrode 11 can be constructed of a silver conductor 100 suspended in a tube 102 of silver chloride solution 104. A tip 106 of the reference electrode 11 should be placed near the nucleating surface 18, such as about 20 mm away from it. In other embodiments, the reference electrode 11 can simply be a silver conductor.

The counter electrode 12 is terminated in a metal plate 108 made of a suitable metal such as platinum, gold, zinc or silver. Platinum is preferred. The area of plate 108 should approximate or be more than the area of the nucleating surface 18.

The apparatus further includes a source 15 of a gas which includes elemental oxygen and, preferably, an inert gas. In the laboratory embodiment this is introduced into vessel 20 by a tube 110. Argon is a preferred inert gas, although Krypton could also be used. The ratio of inert gas to oxygen in the mixture is in the range of 1:9 to about 9:1 by weight and preferably is in the range of about 1:4 to 4:1. More preferably, the oxygen:inert gas ratio falls within the range of 1:1 to 2:1. In the illustrated embodiment this gas is bubbled into solution 19. The use of an inert gas retards the formation of hydroxyl ions.

A predetermined electric potential is applied across electrodes 17 and 11 as by means of a potentiostat electronic controller 10. The voltage from working electrode 13 to reference electrode 11 should be in the range from about 0.7V to about 1.5V. Preferably, the applied potential is in the range from about 1.1V to about 1.4 V. More preferably, the potential should be about 1.2V.

The vessel 20 is sealed by a gas-impermeable and inert seal 14 such as can be constructed of or coated by teflon. The process is preferably conducted at about atmospheric pressure.

A heater 16 keeps solution 19 at a predetermined temperature while the nucleation process is going on. The temperature of solution 19 is held to below 100 C. Preferably, the temperature of solution 19 is held within the range of 50 C to 90 C. More preferably the process temperature is in the range of about 65 C to about 85 C.

The growth process occurs over a time period in the range of about 600 seconds to about 3600 seconds, considerably shorter than prior art growth processes for nanorods. A preferred range for the growth period is 1200 seconds to 3000 seconds. A particularly preferred elapsed time is in the range of 1500 to 2800 seconds. The process can be started and stopped by switching on and off the potentiostat 10.

While a laboratory bench embodiment of the fabrication process and apparatus has been disclosed, the process can be suitably modified and up-scaled for large-scale industrial production of very large arrays.

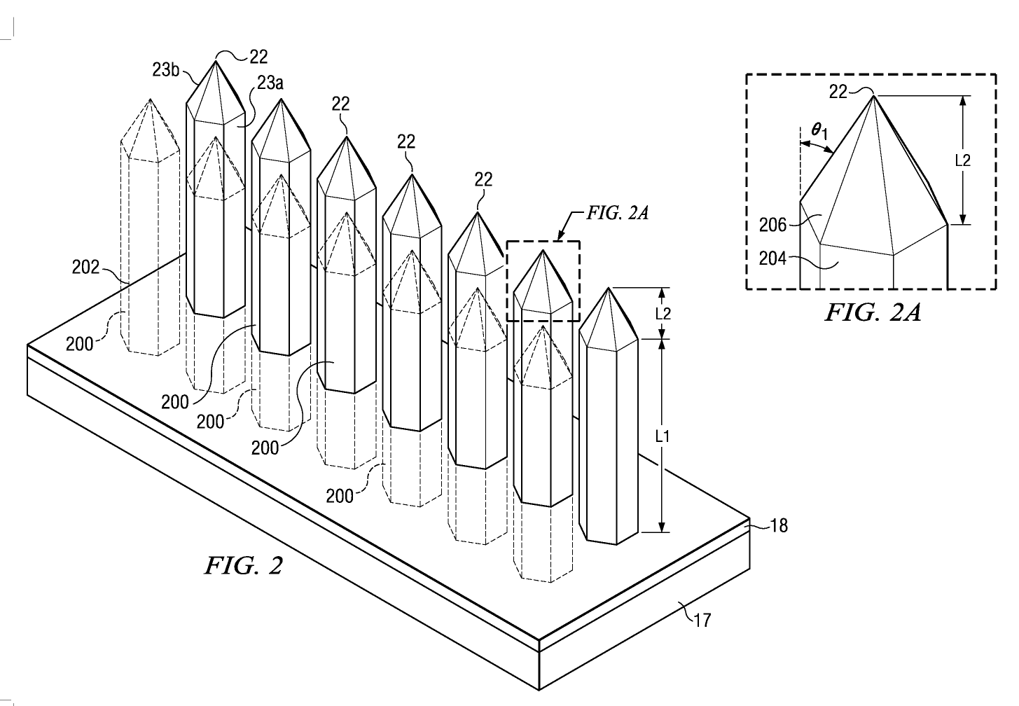

A highly idealized and schematic rendition of the nanostructure array produced under the above conditions is shown in FIG. 2. Under these conditions, a plurality of substantially uniform nanostructures 200 (in this illustrated case, nanotowers) is produced. As measured at the nucleation surface 18 from which the nanotowers 200 grow, each nanotower 200, at its base 202, has a diameter of roughly 200 nanometers. A spacing between nanotower tips 22 is roughly 250 nanometers.

Each nanotower 200 has a first length L₁, extending outwardly or upwardly from the base 202, and a second length L₂ which extends from the end of length L₁ to the tip 22. An important feature of the nanotowers 200 of the invention is that they change in morphology between L₁ and L₂. The cross-sectional area of the nanotowers 200 throughout length L₁ stays substantially the same. The cross-sectional area of the nanotowers 200 along length L₂ decreases as one departs from the end of length L₁ to the tip 22. In a preferred embodiment, each nanotower 200 terminates in a sharp tip 22.

Along length L₁, each nanotower substantially takes the form of a hexagonal prism 204. Along length L₂, each nanotower takes the form of a hexagonal pyramid 206. The nanotowers 200 have a high surface area to volume ratio and thus are particularly efficient electron emitters.

The hexagonal pyramids 206 have sides which slope inwardly toward the pyramid axis of about 45 degrees. Length L₂ is usually on the order of 100 to 150 nanometers. The length L₁ can be somewhat controlled by varying the parameters of the fabrication process, particularly the concentration of zinc ions in the aqueous solution 19, the applied potential and the extent of the nucleating surface. The more zinc there is available to grow the nanotowers with an optimum time period of growth, the longer the nanotowers will grow. Where there is more of a nucleation surface, more zinc will be needed to create the same results. The nucleation of zinc oxide will occur more rapidly if the electric potential is slightly raised, and this in turn will exhaust the available zinc more quickly.

The growth patterns switches from prismatic to pyramidal once the concentration of zinc ions in the aqueous solution decreases below a predetermined minimum, such as 0.0001 M. As growth continues, the concentration of dissolved zinc continues to decrease until there is little left. At this point the tips 22 are created. One characteristic of this process is that while there are two successive periods in which the nanotowers grow in different forms, the same parameters are used in both periods, without any need to change temperature or applied electric potential. The process is thus a “one-shot” process that does not require any intervention to automatically obtain both kinds of crystal growth.

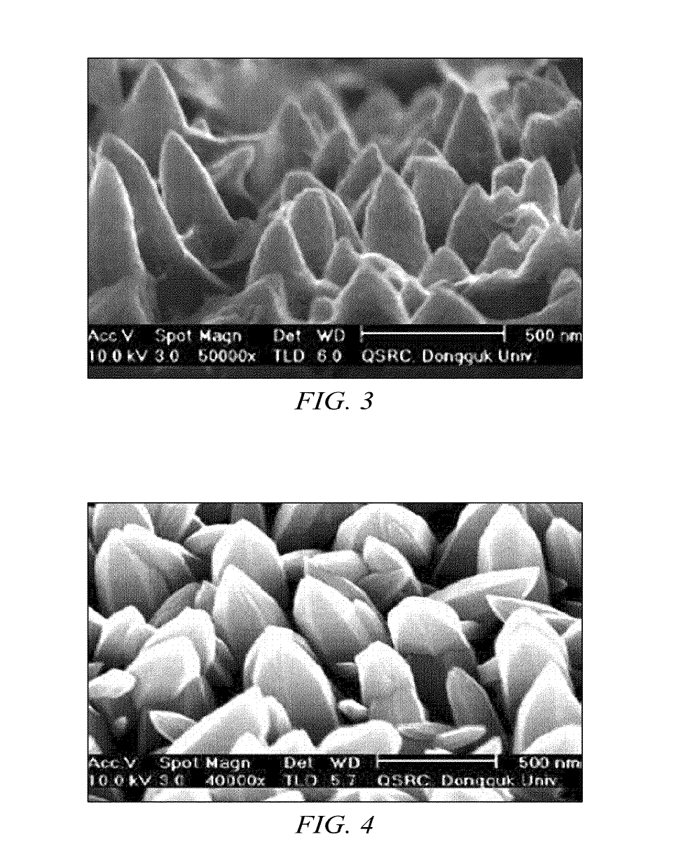

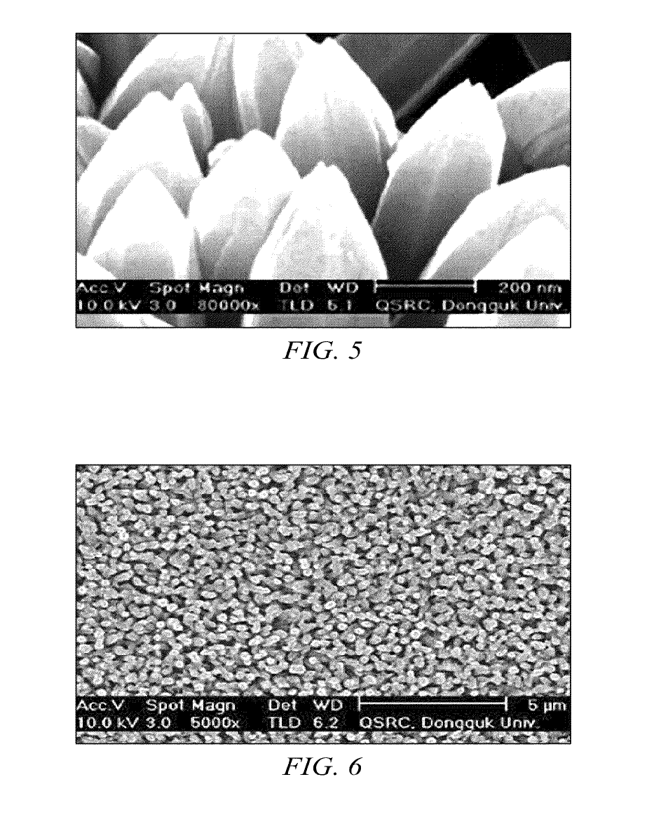

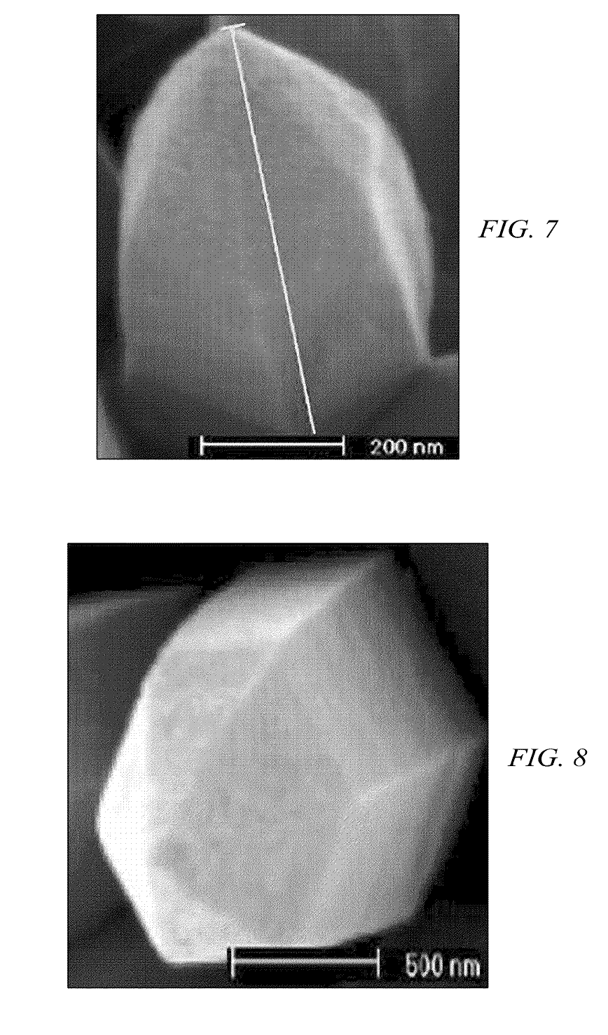

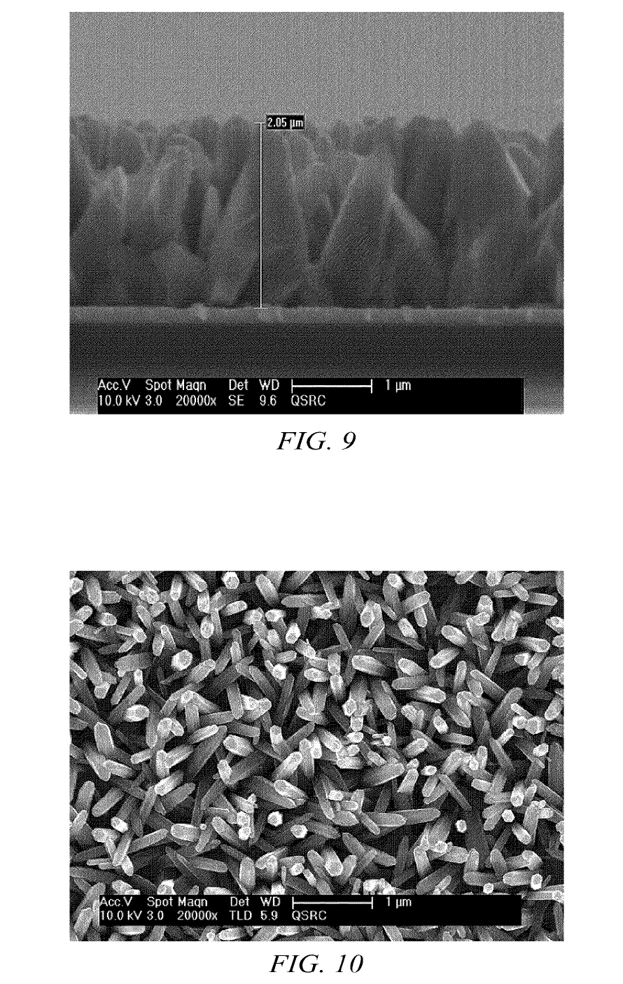

FIGS. 3-10 are scanning electronic micrographs of four nanostructure arrays created according the process of the invention. All of the illustrated arrays were created using the apparatus illustrated in FIG. 1, under atmospheric conditions. The following table sets forth the parameters used in these four examples. Example I is illustrated in FIG. 3, Example II in FIGS. 4-8, Example III in FIG. 9, and Example IV in FIG. 10.

TABLE I

| | Exam- | | | |
|---|---|---|---|---|
| Parameter | ple I | Example II | Example III | Example IV |
| Nucleation surface | ITO on | ITO on glass | ITO on glass | Ni on glass |
| | glass | | | |
| Type of Zn salt | ZnCl₂ | ZnCl₂ | ZnNO₃ | ZnCl₂ |
| Beginning [Zn], M | 0.004 | 0.005 | 0.03 | 0.005 |
| Temperature, C. | 75 | 80 | 80 | 75 |
| Applied Voltage, V | −1.15 | −1.2 | −1.1 | −1.14 |
| Reaction Time, sec. | 2500 | 2700 | 2700 | 2700 |
| O₂:Ar ratio | 1:2 | 1:1 | 1:1 | 1:1 |

In the example illustrated in FIG. 3, useful zinc oxide nanostructures were created that each had pyramidal points or tips. These nanostructures did not have any prismatic section to them.

In the example illustrated in FIGS. 4-8, by contrast the nanotowers have clearly differentiated prismatic and hexapyramidal sections. The nanotowers grew at various angles to the nucleation surface, but all of them are at a considerable angle to the nucleation surface, making them effective, high surface-area-to-volume electron emitters.

While the nanotowers have been generally described as being hexagonal prisms topped with hexapyramids, there are departures from these purely mathematical constructs. The faces of the hexapyramids tend to be slightly convex, while the sides of the hexagonal prisms may be slightly concave. They are nonetheless substantially hexapyramidal and hexagonally prismatic, respectively.

FIG. 9 shows the result of the parameters used in Example III, which are nanostructures of approximately pyramidal shape that are much larger than those obtained with lower zinc concentrations in the aqueous solution. Because of their pointed shapes they will be efficient electron emitters. These nanostructures have basal diameters on the order of one micrometer and a height of about 2.05 micrometers. At these indicated parameters there is less of a change in growth habit as the zinc concentration declines. Relative tall pyramidal structures grow, then there is seen a shoulder and a more pronounced decrease in cross-sectional area as one proceeds toward the tip.

FIG. 10 demonstrates that these nanostructures do not need ITO as a nucleation surface but will nucleate on any conductor. The nucleation surface used in this embodiment is nickel.

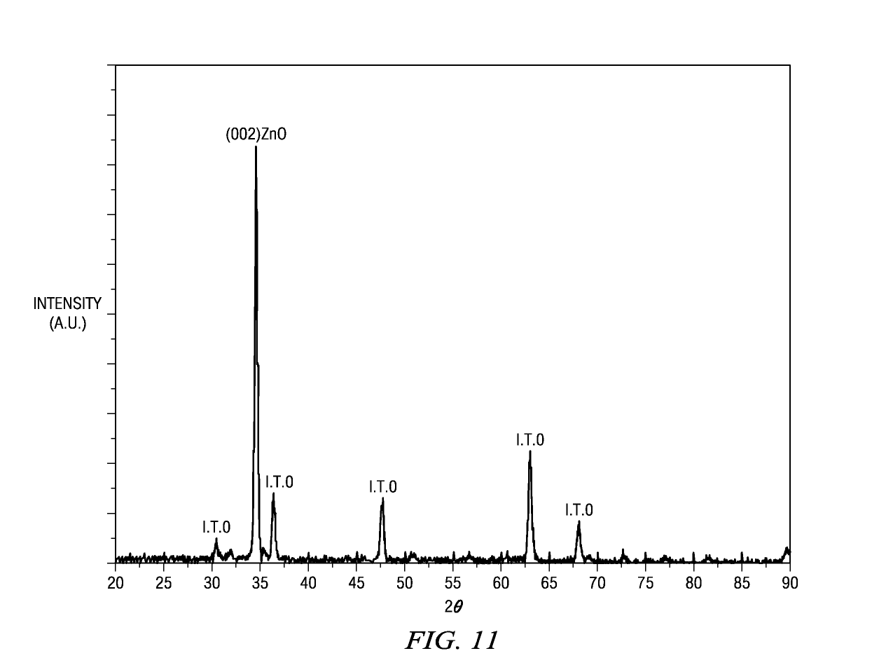

FIG. 11 is a graph of X-ray diffraction data, showing a high peak associated with Zinc oxide in Wurtzite form, and minor peaks each associated with Indium Tin Oxide (the nucleation surface used in Examples I-III).

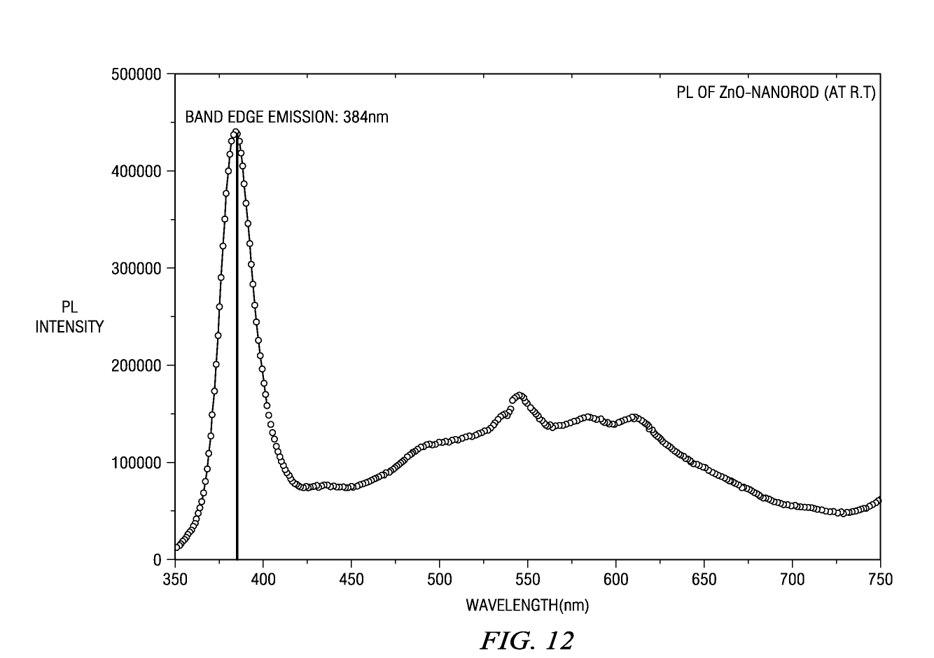

FIG. 12 is a graph of room temperature photoluminescence data on an array fabricated according to the invention, as used to analyze the optical emission properties and crystal quality of the nanostructures. Note the peak at 384 nm.

In summary, a novel electrodeposition process has been shown and described which produces an array of tipped zinc oxide nanotowers at a minimum of time and expense. As produced on transparent conductive substrates, arrays according to the invention have application as field emission lamps and field emission displays.

While illustrated embodiments of the present invention have been described and illustrated in the appended drawings, the present invention is not limited thereto but only by the scope and spirit of the appended claims.

We claim:

1. A process for synthesizing zinc oxide nanostructures by electrodeposition, comprising the steps of:
providing an aqueous solution of a zinc salt;
suspending a working electrode in the aqueous solution, the working electrode having a conductive nucleation surface;
suspending a counter electrode and a reference electrode in the aqueous solution;
applying a predetermined electric potential between the working electrode and the reference electrode;
introducing into the aqueous solution a gas mixture including elemental oxygen; and
responsive to said steps of suspending, applying and introducing, growing an array of spaced-apart zinc oxide nanostructures on the nucleation surface, each nanostructure having a basal diameter adjacent the nucleation surface on the order of 200 nanometers to one micrometer.

2. The process of claim 1, and further comprising the step of formulating the gas mixture to further include an inert gas.

3. The process of claim 2, wherein the inert gas is Argon.

4. The process of claim 1, wherein the process is carried out at atmospheric pressure.

5. The process of claim 2, wherein the ratio of oxygen to inert gas in the introduced gas mixture varies between 1:9 and 9:1.

6. The process of claim 1, wherein the zinc salt is selected from the group consisting of zinc chloride, zinc nitrate and mixtures thereof.

7. The process of claim 5, wherein the concentration of the zinc salt in the aqueous solution is in the range of 0.0001-0.03 M.

8. The process of claim 1, and further comprising the step of growing the array of zinc oxide nanostructures for a period in the range of 600 seconds to 3600 seconds.

9. The process of claim 1, and further comprising the step of maintaining the temperature of the aqueous solution at a temperature below 100 degrees Celsius.

10. The process of claim 1, and further comprising the step of applying the nucleation surface as a coating to a substrate.

11. The process of claim 10, wherein the substrate is transparent.

12. The process of claim 11, wherein the substrate is glass.

13. The process of claim 10, wherein the coating is transparent.

14. The process of claim 13, wherein the coating includes a metal selected from the group consisting of platinum, aluminum, gold, silver, nickel, indium tin oxide, aluminum tin oxide, indium zinc oxide, zinc oxide, cadmium oxide, tin oxide, indium oxide and mixtures thereof.

15. The process of claim 1, wherein the reference electrode comprises silver and silver chloride.

16. The process of claim 1, wherein the counter electrode comprises a metal selected from the group consisting of platinum, silver, gold, zinc and mixtures thereof.

17. The process of claim 1, and further comprising the step of sealing a container containing the aqueous solution prior to growing the nanostructures.

18. The process of claim 13, wherein the container is sealed with a teflon polymer.

19. The process of claim 1, wherein the grown nanostructures are nanorods.

20. The process of claim 1, wherein the grown nanostructures have pointed tips.

21. The process of claim 20, wherein the pointed tips are hexapyramidal.

22. The process of claim 1, and further comprising the steps of
in a first time period, growing the nanostructures as elongate nanotowers of substantially constant areal cross-section, to a first length as measured from the nucleation surface; and
in a second time period following the first time period, growing the nanostructures for a second length spaced from the nucleation surface by the first length, wherein the areal cross section decreases as a function of distance from the first length.

23. The process of claim 22, wherein during the first period the concentration of zinc in the aqueous solution is maintained to be at or above a predetermined concentration, and wherein during the second period the concentration of zinc in the aqueous solution drops below the predetermined concentration and declines as a function of time.

24. An array of zinc oxide nanostructures, comprising:
a conductive nucleation surface;
a plurality of monocrystalline zinc oxide nanostructures grown on the nucleation surface, a base of each of the nanostructures having a diameter on the order of 200 nanometers to one micrometer, each nanostructure having a sharp tip remote from the base and sloping sides extending toward the base from the tip.

25. The array of claim 24, wherein each of the nanostructures is a nanotower, each nanotower having a first length proximate to the base and a second length adjacent the first length and remote from the base, each nanotower having a substantially uniform cross-sectional area through the first length, each nanotower having an areal cross section in the second length which decreases as a function of distance from the first length.

26. The array of claim 25, wherein a shape of the nanotower in the first length is substantially that of a hexagonal prism, a shape of the nanotower in the second length being substantially that of a hexagonal pyramid.

27. The array of claim 24, wherein of the spacing of a nanostructure tip to a next adjacent nanostructure tip is on the order of 250 nanometers to one micrometer.

28. The array of claim 24, wherein the conductive nucleation surface is transparent and is selected from the group consisting of indium tin oxide, aluminum tin oxide, zinc oxide, cadmium oxide, indium zinc oxide, tin oxide, indium oxide, platinum, aluminum, gold, silver and nickel.

29. The array of claim 24, wherein the conductive nucleation surface is a transparent coating on a transparent substrate.

30. The array of claim 29, wherein the substrate is glass.
